(19) United States
(12) Patent Application Publication
(10) Pub. No.: US 2026/0336103 A1
(43) Pub. Date: Oct. 29, 2026

(54) GENERATING ROBOT REWARDS USING SEQUENCE PROCESSING NEURAL NETWORKS

(71) Applicant: Google LLC, Mountain View, CA (US)

(72) Inventors: Wenhao Yu, Mountain View, CA (US); Fei Xia, Santa Clara, CA (US); Nimrod Nathan Gileadi, London (GB); Jie Tan, Mountain View, CA (US); Yuval Tassa, London (GB)

(21) Appl. No.: 19/491,190

(22) PCT Filed: Jun. 10, 2024
(86) PCT No.: PCT/US2024/033284

§ 371 Date: Dec. 8, 2025

Related U.S. Application Data
(60) Provisional application No. 63/471,955, filed on Jun. 8, 2023.

(51) Int. Cl. B25J 9/16; G06N 3/092

(52) U.S. Cl. CPC B25J 9/163; G06N 3/092

(57) ABSTRACT

Methods, systems, and apparatus, including computer programs encoded on a computer storage medium, for controlling a robot using a sequence processing neural network. The sequence processing neural network is used to define a reward function for a given task to be performed by the robot and then the robot is controlled using a robot control policy that is dependent on the reward function.

### CROSS-REFERENCE TO RELATED APPLICATION

This application claims the benefit of U.S. Provisional Application Ser. No. 63/471,955, filed Jun. 8, 2023, which is incorporated by reference herein.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that determines a reward function for a robot interacting with an environment.

Particular embodiments of the subject matter described in this specification can be implemented so as to realize one or more of the following advantages.

Large language models (LLMs) have demonstrated significant progress in acquiring diverse new capabilities through in-context learning, ranging from logical reasoning to code-writing. As a result, some existing techniques have attempted to use LLMs for robotic control. However, since low-level robot actions are hardware-dependent, i.e., the action space from which the LLM must pick depends on the hardware configuration of any given robot and can be significantly different across different robots, and are underrepresented in LLM training corpora, existing efforts in applying LLMs to robotics have largely treated LLMs as semantic planners, which then requires an additional component to map the semantic plans to low-level actions, or relied on human-engineered control primitives to interface with the robot, which limits the applicability of these techniques to a small set of robots and tasks.

The techniques described in this specification, on the other hand, improve robotic control by leveraging the fact that reward functions are flexible representations that can be optimized for control policies to achieve diverse tasks, while their semantic richness makes them suitable to be specified by LLMs. More specifically, the techniques described in this specification utilize an LLM to define reward parameters that can then be optimized to accomplish a variety of robotic tasks. By using reward as the intermediate interface generated by LLMs, the described techniques can effectively bridge the gap between high-level language instructions or corrections to low-level robot actions.

By combining these LLM-generated reward functions with an appropriate control policy, e.g., a real-time model-predictive control (MPC) optimizer, the system can effectively generate a reward function based on a user input and then use the control policy to control the robot in accordance with the reward function. This allows the system to control the robot to effectively perform any of a variety of arbitrary, user-specific tasks without requiring any re-training.

Furthermore, by generating reward functions using LLMs (or other language models) based on natural language input (or other multi-modal user input such as audio and/or video input), the techniques described herein can enable non-expert users to generate and steer novel and intricate robot behaviors without the need for vast amounts of data nor the expertise to engineer low-level primitives. In other words, techniques described herein could be considered to provide a mechanism of providing user input (e.g., entering text) to generate reward functions for controlling a robot, and ultimately to control the robot.

Additionally, this can result in an interactive behavior creation experience where users can immediately observe the results and provide feedback to the system. For instance, in some implementations, multi-step human-in-the-loop interactions can be enabled, where at each step, based on feedback (e.g., the behavior of a robot) a human user can actively engage in a dialogue with the LLM (e.g., by providing human language corrections or additional instructions) to guide the generation of rewards and, consequently, robot behaviors. In this way, users can interactively shape the behavior of robots using, for instance, natural language. In other words, techniques described herein could be considered to assist the user in performing a technical task (e.g., controlling a robot) by means of a continued and/or guided human-machine interaction process.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example robot policy system.

FIG. 2 shows an example of the operations performed by the system relative to other approaches for controlling robots using language model neural networks (LLMs).

FIG. 3 is a flow diagram of an example process for controlling a robot.

FIG. 4 is a flow diagram of an example process for generating the first input sequence.

FIG. 5 shows an example of the operation of the system.

FIG. 6 shows an example of the performance of the described techniques.

Like reference numbers and designations in the various drawings indicate like elements.

### DETAILED DESCRIPTION

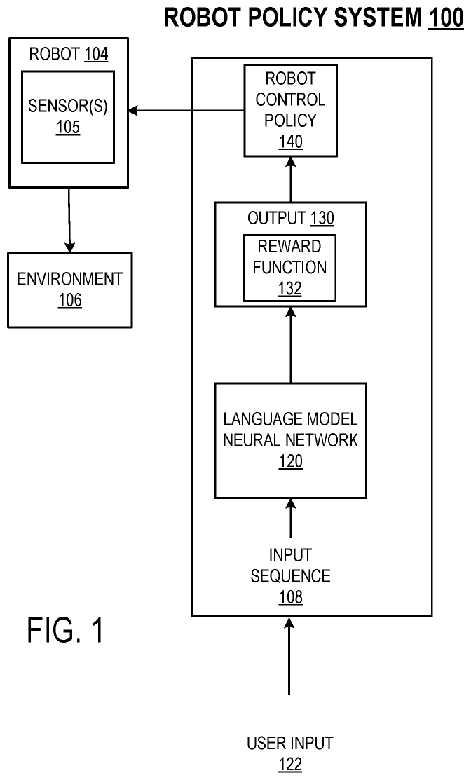

FIG. 1 shows an example robot policy system 100. The robot policy system 100 is an example of a system implemented as computer programs on one or more computers in one or more locations in which the systems, components, and techniques described below are implemented.

The robot policy system 100 controls a robot 104 interacting with an environment 106 to accomplish tasks.

The robot 104 can be any appropriate type of robot, e.g., a robotic arm, a humanoid robot, a quadruped robot, a vehicular robot, e.g., an autonomous vehicle, and so on.

As a general example, the task can include one or more of, e.g., navigating to a specified location in the environment, identifying a specific object in the environment, manipulating the specific object in a specified way, and so on.

The robot 104 generally has one or more sensors 105 that sense the environment, e.g., one or more of the following: camera sensors, laser sensors, radar sensors, temperature sensors, microphone sensors, proprioceptive sensors, e.g., optical encoders, gyroscopes, gyroscopes, accelerometers, inertial measurement units, and so on, etc.

The robot 104 generally also has software that processes readings from these sensors to generate outputs, e.g., machine learning models or other software that detects, localizes, or otherwise characterizes objects in the environment. For example, the robot 104 can have machine learning models that perform object localization, that perform open-vocabulary object detection, and so on. In some cases, this software is located on-board the robot 104 while in other cases this software is located remotely from the robot 104.

Thus, the system 100 can generally obtain, from the sensors 105, the software 104, or both, a variety of information about the current state of the robot 104 and the environment 106 at any given time point. For example, the current state of the robot 140 can include, e.g., the current positions, i.e., locations, poses, or both, of various portions of the robot 104. Similarly, the current state of the environment 106 can include the current positions of objects in the environment 106.

In particular, to control the robot 104, the system 100 receives a user input 122 that describes a task to be performed by the robot 104. The user input 122 can be, e.g., a natural language input that describes the task or a multi-modal input that includes text and images, videos, or audio that collectively describe the task.

The system 100 then generates, from the user input, an output 130 that defines a reward function 132 for the task.

At any given time step during the operation of the robot 104, the reward function 132 maps environment state data, e.g., raw sensor measurements or outputs of the software that processes the sensor measurements, at the given time step to a reward score for the given time step that measures a progress of the robot 104 in completing the task as of the given time step. For instance, the environment state data can be indicative of the current state of the robot 104 and/or the current state of the environment 106, as described above

The system 100 then controls the robot 104 using a robot control policy 140 that is dependent on the reward function 132. Controlling the robot 104 generally refers to repeatedly selecting low-level actions (“control inputs”) to be performed by the robot 104 and then causing the robot 104 to perform the selected actions.

The control inputs to control a robot can include, e.g., torques for the joints of the robot or higher-level control commands. In other words, the control inputs can include for example, position, velocity, or force/torque/acceleration data for one or more joints of a robot or parts of another mechanical robot. Control inputs may additionally or alternatively include electronic control data such as motor control data, or more generally data for controlling one or more electronic devices within the environment the control of which has an effect on the observed state of the environment. In other words, the control inputs can be indicative of low-level actions to be performed by the robot 104.

The control policy 140 can generally be any appropriate policy that controls the robot 104 to optimize rewards that are received by the robot 104, where the rewards are generated by the reward function 132.

As one example, the policy 140 can be a model predictive control (MPC)—based policy.

As another example, the policy 140 can be a machine learned policy that has been trained using the reward function 132. e.g., trained through reinforcement learning.

More generally, the policy 140 can be any appropriate policy that depends on the reward scores generated by the reward function 132.

In more detail, during any given task episode (also referred to as a “rollout” or “task instance”) that has H time steps, the policy 140 needs to map the reward function 132 generated by the system 100 to low-level robot actions aᵢ, . . . , a_{H} that maximize the accumulated reward

$$J ( {a}_{i} , ... , {a}_{H} ) = {\sum }_{t = 0}^{H} R ( {s}_{t} , {a}_{t} )$$

where aₜ is the action at time step t, sₜ is the action at time step t, and R(sₜ, aₜ) is the reward score generated by the reward function 132 given the action at time step t and the state at time step t.

As a particular example, the policy 140 can implement receding horizon trajectory optimization, i.e., model predictive control (MPC). At each control step, MPC plans a sequence of optimized actions a1:H and sends to the robot. The robot applies the action corresponding to its current timestamp, advances to the next step, and sends the updated robot states to the planner to initiate the next planning cycle. The frequent re-planning in MPC empowers its robustness to uncertainties in the system and, importantly, enables interactive motion synthesis and correction. One example of such a policy is the MJPC policy described in T. Howell, N. Gileadi, S. Tunyasuvunakool, K. Zakka, T. Erez, and Y. Tassa. Predictive Sampling: Real-time Behaviour Synthesis with MuJoCo. December 2022. doi:10.48550/arXiv.2212.00541. This policy can implement any of a variety of planning algorithms, e.g., second order planners such as iLQG or zeroth-order planners such as Predictive Sampling.

To determine the reward function 132, the system 100 generates, from the user input, a first input sequence 108.

The system 100 then processes the first input sequence 108 using a first language model neural network 120 to generate, as output, an output sequence 130 that defines the reward function 132 for the task.

Thus, the system 100 uses a language model neural network 120, e.g., a large language model (LLM), to generate the reward function 132. The language model neural network 120 can be, for example, an LLM with a decoder-only or an encoder-decoder Transformer architecture.

As a particular example, the neural network 120 can have the architecture of an auto-regressive language model neural network.

The language model neural network is referred to as an auto-regressive neural network because the neural network auto-regressively generates an output sequence of tokens by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence. For example, the current input sequence when generating a token at any given position in the output sequence can include the context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

More specifically, to generate a particular token at a particular position within a candidate output sequence, the neural network 120 can process the current input sequence to generate a score distribution, e.g., a probability distribution, that assigns a respective score, e.g., a respective probability, to each token in the vocabulary of tokens. The neural network 120 can then select, as the particular token, a token from the vocabulary using the score distribution. For example, the neural network 120 can greedily select the highest-scoring token or can sample, e.g., using nucleus sampling or another sampling technique, a token from the distribution.

As a particular example, the language model neural network 120 can be an auto-regressive Transformer-based neural network that includes (i) a plurality of attention blocks that each apply a self-attention operation and (ii) an output subnetwork that processes an output of the last attention block to generate the score distribution.

The neural network 120 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks. J. Welbl, A. Clark. et al. Training compute-optimal large language models. arXiv preprint arXiv:2203.15556, 2022; J. W. Rae, S. Borgeaud, T. Cai, K. Millican, J. Hoffmann, H. F. Song. J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz. T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway. L. Bennett. D. Hassabis. K. Kavukcuoglu. and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall. Noah Fiedel. Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah. Jared Kaplan, Prafulla Dhariwal, Arvind Neelakantan, Pranav Shvam. Girish Sastrv, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in the given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the neural network 120 is auto-regressive, the system 100 can use the same neural network 110 to generate multiple different candidate output sequences in response to the same request. e.g., by using beam search decoding from score distributions generated by the neural network 110, using a Sample-and-Rank decoding strategy, by using different random seeds for the pseudo-random number generator that's used in sampling for different runs through the neural network 120 or using another decoding strategy that leverages the auto-regressive nature of the neural network.

In some cases, the system 100 directly uses the user input 122 as part of the first input sequence 108.

In some other cases, the system 100 generates, from the user input 122, a second input sequence and processes the second input sequence using a second language model neural network to generate a natural language text sequence describing actions to be performed by the robot to perform the task that the system 100 then includes in the first input sequence 108.

In some implementations, the second and first language model neural networks are the same language model neural network, but the system 100 includes different prompts in the first and second input sequences to cause the language model neural network to generate different types of outputs.

Generating the output 130 that defines the reward function 132 will be described in more detail below.

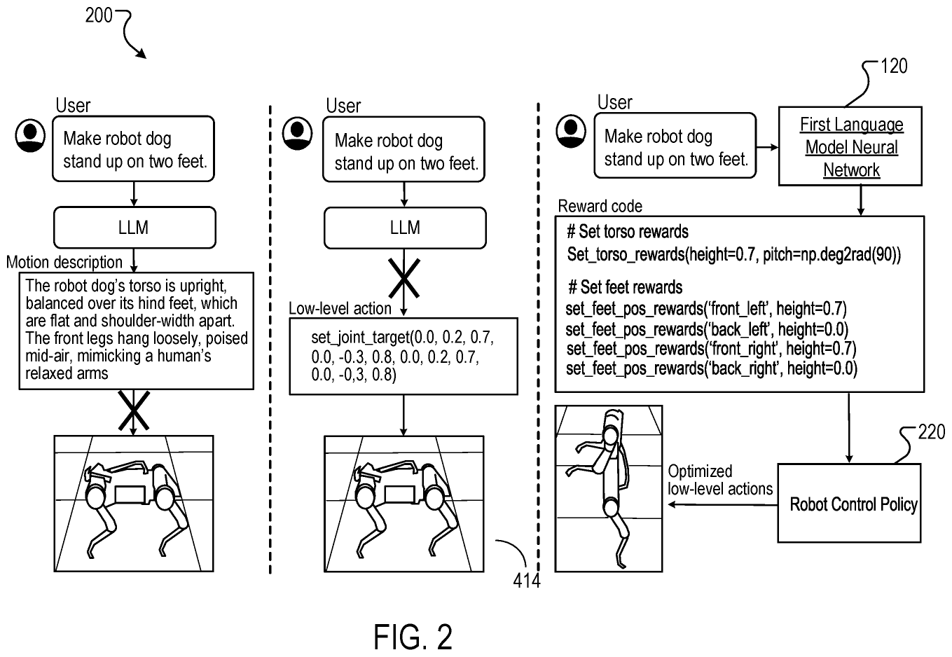

FIG. 2 shows an example 200 of the operations performed by the system 100 relative to other approaches for controlling robots using language model neural networks (LLMs).

In the example 200, the system receives a natural language input “Make robot dog stand up on two feet” that describes a task to be performed by a robot, e.g., a quadruped robot.

As shown in the example 200, some approaches use an LLM to generate a motion description of the motion that is required to perform the task. However, this natural language description of motion of the robot cannot be directly translated into low-level actions to control the robot.

Some other approaches attempt to use the LLM to directly generate low-level action code for controlling the robot. However, low-level code is not well represented in the training data set that an LLM is trained on and the LLM generally cannot accurately generate low-level action code. That is, using the LLM to directly generate low-level actions (in the example of FIG. 2, targets for the joints of the robot), can result in poorly performing actions, actions that are implausible to execute, or actions that cause damage to the robot or to the environment.

The system 100, on the other hand, uses the LLM 120 to map the natural language user input to reward code that defines a reward function for performing the task. In the example 200, the system can then use the reward code to guide a motion controller 220, i.e., the policy 140, that generates low-level actions that optimize the reward function.

Thus, the system 100 bridges the gap between the other two approaches by making use of the reward translator to interpret the user input and transform it into a reward specification. The reward specification is then consumed by a Motion Controller. i.e., the policy 140, that interactively synthesizes a robot motion which optimizes the given reward. Therefore, the LLM does not need to generate low-level actions but can still be effectively incorporated into the control of the robot. For example, language instructions from humans often tend to describe behavioral outcomes instead of low-level behavioral details (e.g., “robot standing up” versus “applying 15 Nm to hip motor”), and therefore the system 100 leverages this discrepancy to connect instructions to rewards rather than to low-level actions given the richness of semantics in rewards.

Moreover, because the motion controller is specifically adapted to robot control, the motion controller can avoid selecting actions that are implausible to execute or that cause damage to the robot or to the environment.

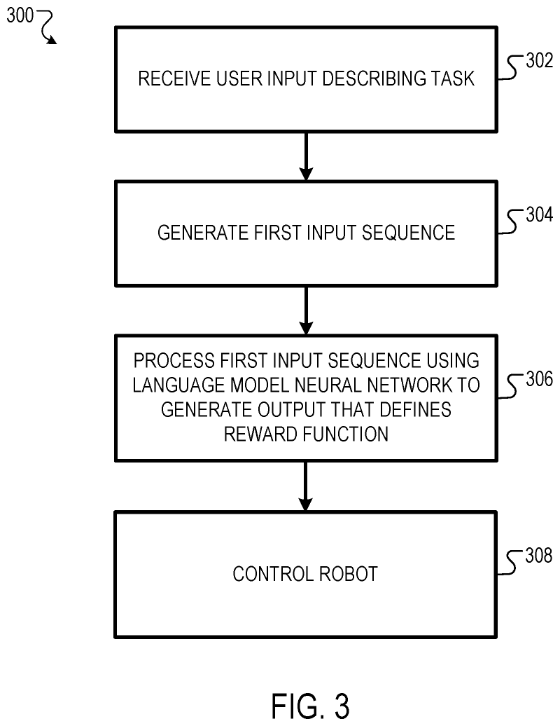

FIG. 3 is a flow diagram of an example process 300 for controlling a robot. For convenience, the process 300 will be described as being performed by a system of one or more computers located in one or more locations. For example, a robot policy system, e.g., the robot policy system 100 of FIG. 1, appropriately programmed in accordance with this specification, can perform the process 300.

The system receives a user input describing a task to be performed by a robot (step 302). The user input can generally be any appropriate input that describes a task. For example, the user input can be natural language text describing the task or audio that has been transcribed into the natural language text describing the task. As another example, the user input can be a multi-modal input that comprises two or more of: an image, a video, text, or audio.

In some cases, the input can be a language input or multi-modal input that is generated based on brain signals or some other bodily input, e.g., by performing visual speech recognition on the mouth of a user, or by performing gaze detection on a gaze of a user.

The system generates, from the user input, a first input sequence (step 304).

In some cases, the first input sequence includes the user input. For example, the first user input can include a prompt and the user input.

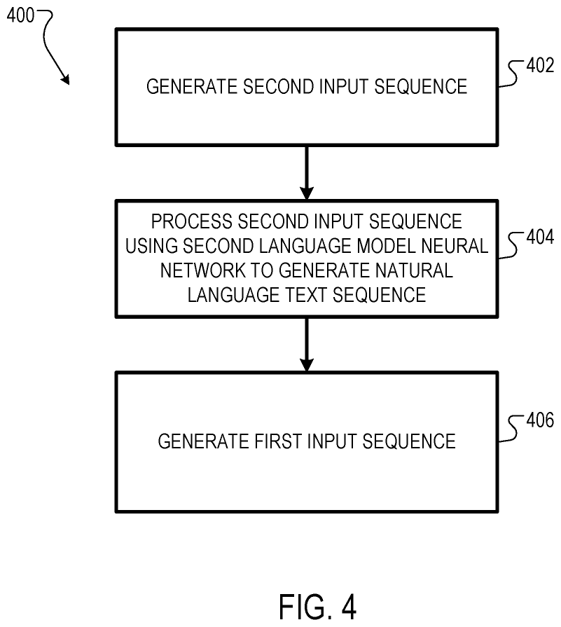

In some other cases, the system performs one or more intermediate steps on the user input to generate the first input sequence. This is described in more detail below with reference to FIG. 4.

Generally, however, the first input sequence includes (i) information specifying the task and (ii) context information characterizing the robot and the environment.

As a particular example of (ii), the first input sequence can include a context sequence that specifies one or more application programming interfaces (APIs) that can be called to obtain reward scores generated from one or more sensor readings of the environment.

The APIs can include any of a variety of APIs that can be called to obtain information about the state of the robot or the state of the environment and to transform that information into a reward score based on the arguments of the call.

For example, the one or more APIs can include an API that outputs a reward score based on a respective target position of one or more objects in the environment. In this example, the first input sequence can also include a context sequence that identifies a set of objects that are present in the environment, e.g., as determined from outputs generated by the software of the robot. One example of such an API is an API that outputs, for a given object, a reward score that is based on the distance between the current position of the object and the target position of the object.

As another example, the one or more APIs can include an API that outputs a reward score based on a respective target position of a particular portion of the robot in the environment. One example of such an API is an API that outputs, for a given portion of the robot, a reward score that is based on the distance between the current position of the portion and the target position of the portion. For example, the portion of the robot can be one of the joints of the robot, the body of the robot, one of the feet of the robot, and so on.

An example set of APIs that can be called for a quadruped robot is given below in Table 1. In the example of Table 1, the reward function is a weighted sum of the outputs of the APIs (also referred to as “residual terms”). Therefore, Table 1 also shows the default weights for each of the API outputs in the weighted sum. These default weights can be adjusted, e.g., by the user or by outputs generated by the first language model neural network.

TABLE 1

| Residual Term | Formulation | Default weight |
|---|---|---|
| CoM X-Y position | \|p_{xy} − p [symbol] \| | 0.3 |
| CoM height | p_{z} − [symbol] | 1.0 |
| base yaw | p_{yaw} − p [symbol] | 0.3 |
| base pitch | p_{pitch} − p [symbol] | 0.6 |
| base roll | pᵣₒₗₗ − p [symbol] | 0.1 |
| forward velocity | [symbol] ₓ − [symbol] | 0.1 |
| sideways velocity | [symbol] _{y} − [symbol] | 0.1 |
| yaw speed | [symbol] _{yaw} − [symbol] | 0.1 |
| foot local position x | fpₓ − f [symbol] ₓ | 1 |
| foot local position y | fp_{y} − f [symbol] _{y} | 1 |
| foot local position z | fp_{z} − f [symbol] _{z} | 2 |

[symbol]

indicates data missing or illegible when filed

In Table 1, each residual term measures a residual, e.g., a difference or absolute value of a difference, between a quantity referenced in the “residual term” column and a target value for the quantity (denoted with an accent, so that p refers the target value for the corresponding quantity p). Residual terms that refer to feet can be repeated for all four feet of the quadruped robot.

An example set of APIs that can be called for a manipulator robot is given below in Table 2. In the example of Table 2, the reward function is a weighted sum of the outputs of the APIs (also referred to as “residual terms”). Therefore, Table 2 also shows the default weights for each of the API outputs in the weighted sum. These default weights can be adjusted. e.g., by the user or by outputs generated by the first language model neural network.

TABLE 2

| Residual Term | Formulation | Default weight |
|---|---|---|
| move obj1 close to obj2 | \|c1_{xyz} − c2_{xyz}\| | 5 |
| move obj to target X-Y position | \|c [symbol] − [symbol] \| | 5 |
| move obj to target height | \|c_{xy} − [symbol] \| | 10 |
| move obj to target orientation | \|o_{obj} − [symbol] \| | |
| move joint to target value | q − [symbol] | 10 |

[symbol]

indicates data missing or illegible when filed

In Table 1, each residual term measures a residual, e.g., a difference or absolute value of a difference, between two quantities referenced in the “residual term” column. e.g., a quantity and a corresponding target value for the quantity (denoted the same way as in Table 1) or the same quantity for two different objects in the environment.

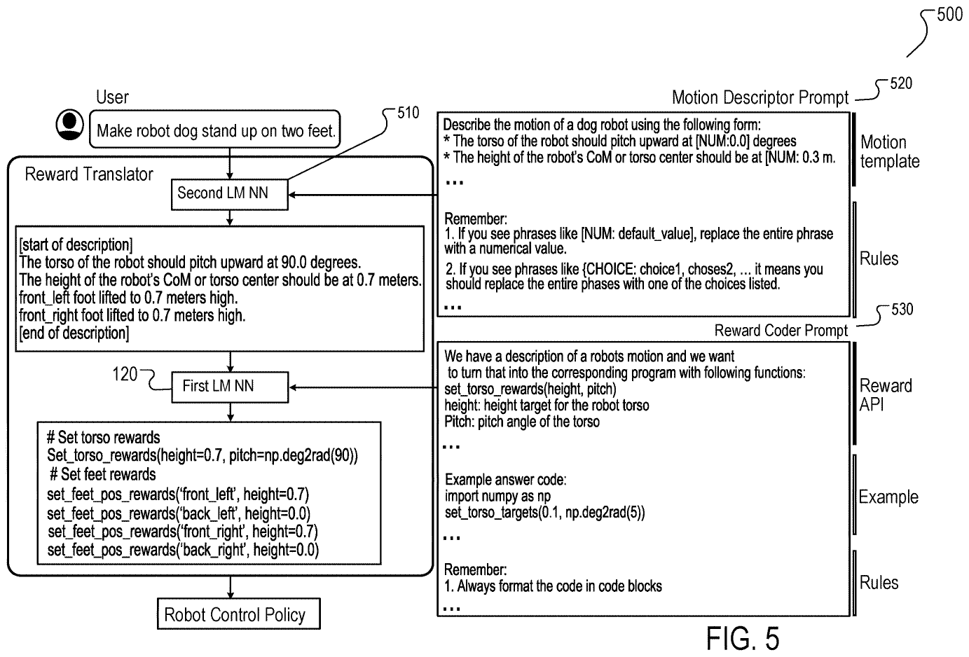

Optionally, the first input sequence can also include a template natural language sequence for specifying the reward function. That is, the template natural language sequence can include one or more of (i) a natural language instruction that instructs the LLM how to specify the reward function, (ii) one or more examples that each include example information specifying an example task and an example output sequence that specifies the reward function for the example task, or (iii) both. An example template is described below with reference to FIG. 5.

The system processes the first input sequence using a first language model neural network to generate, as output, an output sequence that defines a reward function for the task (step 306). As described above, the reward function maps environment state data at a given time step to a reward score for the given time step that measures a progress of the robot in completing the task.

Generally, the output sequence specifies arguments of a computation that maps the environment state data to the reward value for the given time step.

For example, as described above, the input sequence can include a context that specifies one or more application programming interfaces (APIs) that can be called to obtain reward scores generated from one or more sensor readings of the environment.

In this example, the output sequence can include computer code representing a respective call to each of one of the one or more APIs and arguments for the call. The reward function can then be based on reward scores output by the one or more APIs called in the output sequence. For example, at any given time step, the reward function can be a sum or a weighted sum of the reward scores returned by the APIs called in the output sequence. As another example, the reward function can be a sum or a weighted sum of a respective norm of each of the reward scores returned by the APIs called in the output sequence. Because the APIs will generally return different reward scores given different environment states, the reward function is a state-dependent reward function as described above.

As a particular example, when the one or more APIs can include an API that outputs a reward score based on a respective target position of one or more objects in the environment, the output sequence can include arguments to a call to this API that specify the target position and identify the one or more objects. This can allow the API to compare the target position(s) of the one or more objects to the current position(s) of the one or more objects to determine the reward score.

As another example, when the one or more APIs include an API that outputs a reward score based on a respective target position of a particular portion of the robot in the environment, the output sequence can include arguments to a call to this API that specify the target position and identify the particular portion of the robot. This can allow the API to compare the target position of the specified portion to the current position of the specified portion to determine the reward score.

The system controls the robot using a robot control policy that is dependent on the reward function (step 308).

As described above, the robot control policy can be any appropriate robot control policy. Generally, the control policy controls the robot to maximize aggregated rewards computed using the reward function.

For example, as described above, the policy can be a model predictive control (MPC) policy.

As another example, the control policy can be a machine learning model that has been trained through reinforcement learning using reward scores generated by the reward function. In some of these cases, prior to controlling the robot using the control policy, the system trains the machine learning model through reinforcement learning using reward scores generated by the reward function. For example, the system can perform this training using off-policy reinforcement learning or in simulation. In others of these cases, the system controls the robot using the control policy in order to generate the training data that is used to train the control policy, i.e., controls the robot during learning.

As yet another example, the control policy can employ offline trajectory optimization using the reward function. An example of such a control policy is the rapidly exploring random tree algorithm.

In some implementations, the system directly uses the robot control policy to control the robot. In these implementations, the system controls the robot by, at each of multiple time steps during a task episode, receiving an observation characterizing a state of the environment at the time step, applying the control policy to the observation generate a control input (i.e., a low-level action) for the robot, and applying the control input to the robot.

In some other implementations, e.g., when the robot control policy is deployed on-board the robot and the system is remote from the robot, the system can provide data specifying the reward function to a control system for the robot to cause the control system to control the robot using the reward function.

FIG. 4 is a flow diagram of an example process 400 for generating the first input sequence. For convenience, the process 400 will be described as being performed by a system of one or more computers located in one or more locations. For example, a robot policy system, e.g., the robot policy system 100 of FIG. 1, appropriately programmed in accordance with this specification, can perform the process 400.

The system generates, from the user input, a second input sequence (step 402).

Generally, the second input sequence includes the user input and prompt information that causes a LLM to generate a motion plan that describes the motion required for the robot to carry out the task characterized by the user input.

For example, the second input sequence can also include, in addition to the user input, a template natural language sequence for describing robot motion. That is, the template natural language sequence can include one or more of (i) a natural language instruction that instructs the LLM how to describe the robot motion that is required to carry out the task specified by the user input, (ii) one or more examples that each include example information specifying an example task and an example output sequence that specifies the reward function for the example task, or (iii) both. As a particular example of this, the natural language instruction can include a motion template that describes the form of a motion plan and a set of rules for how to generate the motion plan. An example template is described below with reference to FIG. 5.

The system processes the second input sequence using a second language model neural network to generate a natural language text sequence describing actions to be performed by the robot to perform the task (step 404). Generally, the second language model neural network can be the same as the first language model neural network, but because the second input sequence includes different prompt information than the first input sequence, the language model neural network generates an output that describes a motion plan rather than an output that defines a reward sequence.

The system generates the first input sequence (step 406). For example, the system can include, as the information specifying the task, the natural language text sequence describing the actions, such that the first input sequence includes (i) the natural language text sequence, (ii) the context information characterizing the robot and the environment, and, optionally, (ii) the template.

FIG. 5 shows an example 500 of the operation of the system 100. As can be seen from the example 500, the system receives the user input “Make robot dog stand up on two feet.”

The system then uses the second language model neural network 510 (“motion descriptor”) to generate a motion plan sequence that describes the actions that the robot needs to perform in order to perform the task, i.e., to stand up on two feet. As can be seen from the example, this sequence includes statements like “The torso of the robot should pitch upward at 90.0 degrees” which are useful for determining how to control the robot but that cannot be directly mapped to low-level actions.

In particular, to generate the motion plan sequence, the system processes, using the second language model neural network 510, a “second” input sequence that includes a motion descriptor prompt 520 that includes (i) a motion template that defines the form of the motion plan sequence and (ii) a set of rules to follow to adapt the motion template into the motion plan sequence.

The system then uses the first language model neural network 120 (“reward coder”) to generate, from the motion plan sequence, an output sequence that defines the reward. In particular, in the example 500, the output sequence is code that includes five API calls to two different APIs, one that returns reward scores based on a position of the torso of the robot and one that returns reward scores based on a position of the robot. Each of the API calls specifies a target position. e.g., a target height or a target height and pitch, of the corresponding portion of the robot. The reward function can then be a combination, e.g., a sum or a weighted sum, of the reward scores returned by these five APIs.

In particular, to generate the motion plan sequence, the system processes, using the first language model neural network 120, a “first” input sequence that includes a reward code prompt 530 that includes (i) context that specifies the reward APIs that are available to be called, (ii) an example of an output sequence, and (iii) a set of rules to follow when generating the output sequence.

The system can then provide the output sequence, e.g., the code, to the motion controller, i.e., the control policy, to allow the control policy to control the robot in accordance with the reward function.

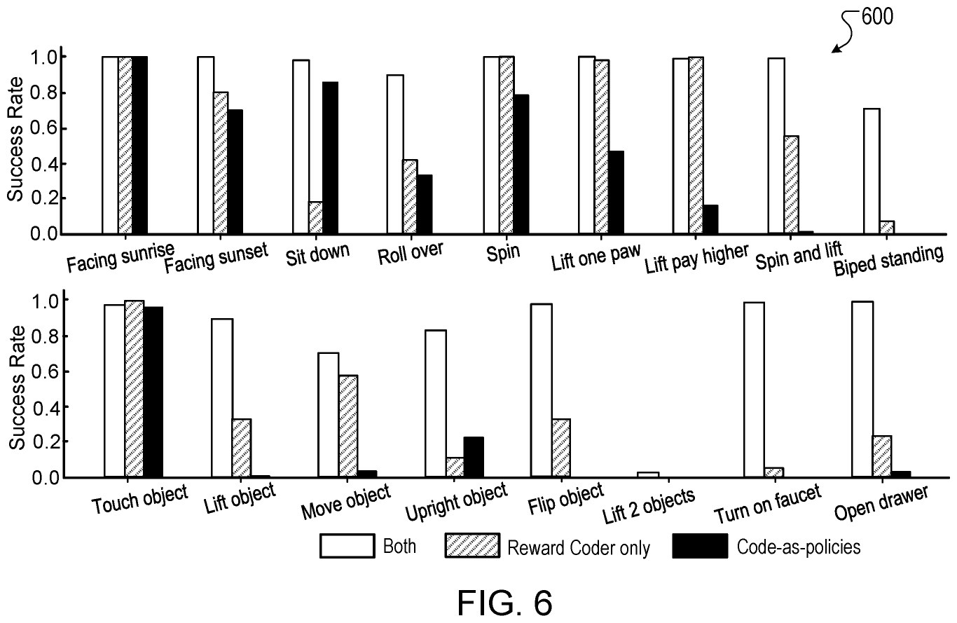

FIG. 6 shows an example 600 of the performance of the described techniques on a variety of different tasks controlling a variety of different robots, with the top row of tasks being tasks for a quadruped robot and the bottom row of tasks being tasks for a manipulator robot. In particular, the example 600 shows the performance of two variants of the described techniques: (i) “both” which first generates the second input sequence from the user input and then uses the second input sequence to generate the first input sequence and (ii) “reward coder only” which directly uses the user input to generate the first input sequence relative.

The performance is shown relative to an existing technique “code-as-policies” which attempts to directly use an LLM to generate code for controlling the robot by parametrizing a set of control primitives that are specific to the corresponding robot. As can be seen from FIG. 6, the “reward coder only” variant outperforms code-as-policies on many tasks and is at least comparable with code-as-policies on almost all tasks despite not having access to any manually designed control primitives. Moreover, the “both” variant significantly outperforms code-as-policies on almost all tasks and is at least comparable to code-as-policies on all tasks, showing that including the intermediate step of motion planning can improve the quality of the reward functions generated by the system.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

While this specification generally refers to “language model neural networks” it will be understood that this term generally refers to any appropriate type of sequence processing neural network that processes an input sequence of tokens to an output sequence of tokens. That is, the neural networks that generate the output sequence and the natural language text sequence can equivalently be referred to as “sequence processing neural networks.” Examples of such neural networks include LLMs, large multi-modal models (LMMs) that process and generate tokens representing multiple modalities of data, visual language model (VLMs), and so on.

Moreover, while this specification refers to the system processing a “user input” it should be understood that the input can be received from any appropriate source, e.g., from a user or from another system of one or more computers.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data. e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data. e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device. e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN). e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:

Clause 1. A method performed by one or more computers, the method comprising:
receiving a user input describing a task to be performed by a robot;
generating, from the user input, a first input sequence;
processing the first input sequence using a first language model neural network to generate, as output, an output sequence that defines a reward function for the task, wherein the reward function maps environment state data at a given time step to a reward score for the given time step that measures a progress of the robot in completing the task; and
controlling the robot using a robot control policy that is dependent on the reward function.
   Clause 2. The method of clause 1, wherein the user input is natural language text describing the task or audio that has been transcribed into the natural language text describing the task.
   Clause 3. The method of clause 2, wherein the user input is a multi-modal input that comprises two or more of: an image, a video, text, or audio.
   Clause 4. The method of any one of clauses 1-3, wherein the first input sequence comprises the user input.
   Clause 5. The method of any preceding clause, wherein generating, from the user input, a first input sequence comprises:
generating, from the user input, a second input sequence; and
processing the second input sequence using a second language model neural network to generate a natural language text sequence describing actions to be performed by the robot to perform the task, and
wherein the first input sequence comprises the natural language text sequence.
   Clause 6. The method of clause 4 or clause 5, wherein the first input sequence further comprises:
a context sequence that specifies one or more application programming interfaces (APIs) that can be called to obtain reward scores generated from one or more sensor readings of the environment;
the output sequence comprises computer code representing a respective call to one of the one or more APIs and arguments for the call; and
the reward function is based on reward scores output by the one or more APIs called in the output sequence.
   Clause 7. The method of clause 6, wherein the one or more APIs comprise a first API that outputs a reward score based on a respective target position of one or more objects in the environment, and wherein the arguments to the call to the first API specify the target position and identify the one or more objects.
   Clause 8. The method of clause 7, wherein the first input sequence comprises a context sequence that identifies a set of objects that are present in the environment.
   Clause 9. The method of any one of clauses 6-8, wherein the one or more APIs comprise a second API that outputs a reward score based on a respective target position of a particular portion of the robot in the environment, and wherein the arguments to the call to the second API specify the target position and identify the particular portion.
   Clause 10. The method of any preceding clause, when dependent on clause 5, wherein the second input sequence comprises a template natural language sequence for describing robot motion.
   Clause 11. The method of any preceding clause, wherein the first input sequence comprises a template natural language sequence for specifying the reward function.
   Clause 12. The method of any preceding clause, wherein controlling the robot using a robot control policy that is dependent on the reward function comprises:
providing data specifying the reward function to a control system for the robot to cause the control system to control the robot using the reward function.
   Clause 13. The method of any one of clauses 1-11, wherein controlling the robot using a robot control policy that is dependent on the reward function comprises, at each of a plurality of time steps during a task episode:
receiving an observation characterizing a state of the environment at the time step;
applying the control policy to the observation generate a control input for the robot; and
applying the control input to the robot.
   Clause 14. The method of any preceding clause, wherein the control policy controls the robot to maximize aggregated rewards computed using the reward function.
   Clause 15. The method of any preceding clause, wherein the output sequence specifies arguments of a computation that maps the environment state data to the reward value for the given time step.
   Clause 16. The method of any preceding clause, wherein the control policy is a model predictive control (MPC) policy.
   Clause 17. The method of any preceding clause, wherein the control policy is a machine learning model that has been trained through reinforcement learning using reward scores generated by the reward function.
   Clause 18. The method of clause 17, further comprising:
prior to controlling the agent using the control policy, training the machine learning model through reinforcement learning using reward scores generated by the reward function.
   Clause 19. The method of any preceding clause, wherein the control policy employs offline trajectory optimization using the reward function.
   Clause 20. A system comprising:
one or more computers; and
one or more storage devices communicatively coupled to the one or more computers, wherein the one or more storage devices store instructions that, when executed by the one or more computers, cause the one or more computers to perform the operations of the respective method of any one of clauses 1-19.
   Clause 21. One or more non-transitory computer storage media storing instructions that when executed by one or more computers cause the one or more computers to perform the operations of the respective method of any one of clauses 1-19.

What is claimed is:

1. A method performed by one or more computers, the method comprising:
receiving an input describing a task to be performed by a robot;
generating, from the input, a first input sequence;
processing the first input sequence using a first language model neural network to generate, as output, an output sequence that defines a reward function for the task, wherein the reward function maps environment state data at a given time step to a reward score for the given time step that measures a progress of the robot in completing the task; and
controlling the robot using a robot control policy that is dependent on the reward function.

2. The method of claim 1, wherein the input is natural language text describing the task or audio that has been transcribed into the natural language text describing the task.

3. The method of claim 2, wherein the input is a multi-modal input that comprises two or more of: an image, a video, text, or audio.

4. The method of claim 1, wherein the first input sequence comprises the input.

5. The method of claim 1, wherein generating, from the input, a first input sequence comprises:
generating, from the input, a second input sequence; and
processing the second input sequence using a second language model neural network to generate a natural language text sequence describing actions to be performed by the robot to perform the task, and
wherein the first input sequence comprises the natural language text sequence.

6. The method of claim 4, wherein the first input sequence further comprises:
a context sequence that specifies one or more application programming interfaces (APIs) that can be called to obtain reward scores generated from one or more sensor readings of the environment;
the output sequence comprises computer code representing a respective call to one of the one or more APIs and arguments for the call; and
the reward function is based on reward scores output by the one or more APIs called in the output sequence.

7. The method of claim 6, wherein the one or more APIs comprise a first API that outputs a reward score based on a respective target position of one or more objects in the environment, and wherein the arguments to the call to the first API specify the target position and identify the one or more objects.

8. The method of claim 7, wherein the first input sequence comprises a context sequence that identifies a set of objects that are present in the environment.

9. The method of claim 6, wherein the one or more APIs comprise a second API that outputs a reward score based on a respective target position of a particular portion of the robot in the environment, and wherein the arguments to the call to the second API specify the target position and identify the particular portion.

10. The method of claim 5, wherein the second input sequence comprises a template natural language sequence for describing robot motion.

11. The method of claim 1, wherein the first input sequence comprises a template natural language sequence for specifying the reward function.

12. The method of claim 1, wherein controlling the robot using a robot control policy that is dependent on the reward function comprises:
providing data specifying the reward function to a control system for the robot to cause the control system to control the robot using the reward function.

13. The method of claim 1, wherein controlling the robot using a robot control policy that is dependent on the reward function comprises, at each of a plurality of time steps during a task episode:
receiving an observation characterizing a state of the environment at the time step;
applying the control policy to the observation generate a control input for the robot; and
applying the control input to the robot.

14. The method of claim 1, wherein the control policy controls the robot to maximize aggregated rewards computed using the reward function.

15. The method of claim 1, wherein the output sequence specifies arguments of a computation that maps the environment state data to the reward value for the given time step.

16. The method of claim 1, wherein the control policy is a model predictive control (MPC) policy.

17. The method of claim 1, wherein the control policy is a machine learning model that has been trained through reinforcement learning using reward scores generated by the reward function.

18. The method of claim 17, further comprising:
prior to controlling the robot using the control policy, training the machine learning model through reinforcement learning using reward scores generated by the reward function.

19. (canceled)

20. A system comprising:
one or more computers; and
one or more storage devices communicatively coupled to the one or more computers, wherein the one or more storage devices store instructions that, when executed by the one or more computers, cause the one or more computers to perform operations comprising:
receiving an input describing a task to be performed by a robot;
generating, from the input, a first input sequence;
processing the first input sequence using a first language model neural network to generate, as output, an output sequence that defines a reward function for the task, wherein the reward function maps environment state data at a given time step to a reward score for the given time step that measures a progress of the robot in completing the task; and
controlling the robot using a robot control policy that is dependent on the reward function.

21. One or more non-transitory computer storage media storing instructions that when executed by one or more computers cause the one or more computers to perform operations comprising:
receiving an input describing a task to be performed by a robot;
generating, from the input, a first input sequence;
processing the first input sequence using a first language model neural network to generate, as output, an output sequence that defines a reward function for the task, wherein the reward function maps environment state data at a given time step to a reward score for the given time step that measures a progress of the robot in completing the task; and
controlling the robot using a robot control policy that is dependent on the reward function.
